(19) United States
(12) Patent Application Publication
(10) Pub. No.: US 2024/0125333 A1
(43) Pub. Date: Apr. 18, 2024

(54) SUCTION PIPE OF CENTRIFUGAL COMPRESSOR, CENTRIFUGAL COMPRESSOR WITH SUCTION PIPE, AND REFRIGERATOR

(71) Applicant: Panasonic Intellectual Property Management Co., Ltd., Kadoma-shi, Osaka (JP)

(72) Inventors: Hidetoshi TAGUCHI, Osaka (JP); Ko INAGAKI, Shiga (JP); Masaya HONMA, Hyogo (JP); Takumi HIKICHI, Osaka (JP)

(21) Appl. No.: 18/546,540

(22) PCT Filed: Feb. 4, 2022
(86) PCT No.: PCT/JP2022/004563

§ 371 Date: Aug. 15, 2023

(30) Foreign Application Priority Data
Feb. 17, 2021 (JP) 2021-023530

(51) Int. Cl. F04D 29/54; F04D 17/10

(52) U.S. Cl. CPC F04D 29/54; F04D 17/10

(57) ABSTRACT

A suction pipe 200 of a centrifugal compressor 20, the centrifugal compressor 20 having a suction port 22 that is open to direct the working fluid to an impeller 21, the suction pipe 200 including a first opening portion 31 to be directly or indirectly connected to the suction port 22 and a second opening portion 32 positioned upstream from the first opening portion 31 in the flow direction of the working fluid. The second opening portion 32 is positioned below the first opening portion 31 in the vertical direction. The first opening portion 31 and the second opening portion 32 are open toward the same direction.

### TECHNICAL FIELD

The present disclosure relates to a suction pipe of a centrifugal compressor, a centrifugal compressor with a suction pipe, and a refrigerator.

### BACKGROUND ART

Patent Literature 1 discloses a deicer for deicing an air inlet of an internal combustion engine such as a gas turbine. The deicer includes a gas turbine of a turbine engine, an enclosure having opening portions and for admitting air into the engine, and an electromagnetic wave generator for generating electromagnetic waves in the enclosure at a frequency suitable for melting ice.

### CITATION LIST

### Patent Literature

Patent Literature 1: JP 2010-522296 A

### SUMMARY OF INVENTION

### Technical Problem

Compressors may be subjected to the entry of ice flakes and water droplets through a suction pipe connected to the suction port of the compressors. The entry of ice flakes and water droplets into compressors damages the elements such as the impeller.

The present disclosure provides a technique for preventing ice flakes and water droplets from entering compressors.

### Solution to Problem

A suction pipe according to the present disclosure is a suction pipe of a centrifugal compressor, the centrifugal compressor having a suction port that is open to direct a working fluid to an impeller,
the suction pipe including:
a first opening portion to be directly or indirectly connected to the suction port; and
a second opening portion positioned upstream from the first opening portion in a flow direction of the working fluid, wherein
the second opening portion is positioned below the first opening portion in a vertical direction, and
the first opening portion and the second opening portion are open toward the same direction.

In another aspect, a centrifugal compressor with a suction pipe according to the present disclosure includes:
a centrifugal compressor; and
the suction pipe according to the present disclosure, the suction pipe being connected to the centrifugal compressor.

In still another aspect, a refrigerator according to the present disclosure includes the centrifugal compressor with a suction pipe according to the present disclosure.

Advantageous Effects of Invention

According to the technique of the present disclosure, it is possible to prevent ice flakes and water droplets from entering compressors.

### BRIEF DESCRIPTION OF DRAWINGS

FIG. 1 is a front view showing a suction pipe of a centrifugal compressor of Embodiment 1 together with the centrifugal compressor.

FIG. 2 is a longitudinal sectional view of the suction pipe and the centrifugal compressor taken along line II-II.

FIG. 3 is a longitudinal sectional view showing a suction pipe of a centrifugal compressor of Embodiment 2 together with the centrifugal compressor.

FIG. 4 is a front view showing a suction pipe of a centrifugal compressor of Embodiment 3 together with the centrifugal compressor.

FIG. 5 is a longitudinal sectional view of the suction pipe and the centrifugal compressor taken along line V-V.

FIG. 6 is a configuration diagram of a refrigerator of Embodiment 4.

FIG. 7A is a front view of the refrigerator.

FIG. 7B is a right-side view of the refrigerator.

FIG. 7C is a left-side view of the refrigerator.

### DESCRIPTION OF EMBODIMENTS

(Findings Etc. On which the Present Disclosure is Based)

At the time when the inventors came to the present disclosure, one known problem for the case where a compressor using air as the working fluid operates in a low-temperature environment was the generation of water droplets and ice from water vapor contained in air. The entry of water droplets and ice flakes into compressors damages the elements such as the impeller. To address this problem, Patent Literature 1 proposes using an electromagnetic wave generator such as a magnetron to generate electromagnetic waves in the enclosure at a frequency suitable for melting ice.

However, to entirely heat the working fluid necessary for the operation of the compressor, the electromagnetic wave generator needs to be increased in size. This requires an excessive amount of electric power and is economically inefficient accordingly. The inventors found this problem, and have come to constitute the subject matter of the present disclosure in order to solve this problem.

Therefore, the present disclosure provides a technique for preventing ice flakes and water droplets from entering compressors.

Embodiments will be described below in detail with reference to the drawings. However, more detailed description than necessary may be omitted. For example, detailed description of a well-known matter or overlapping description of substantially the same structure may be omitted. This is to prevent the following description from being unnecessarily redundant and facilitate the understanding by those skilled in the art.

The accompanying drawings and the following description are provided for those skilled in the art to fully understand the present disclosure, and are not intended thereby to limit the subject matter recited in the claims.

### EMBODIMENT 1

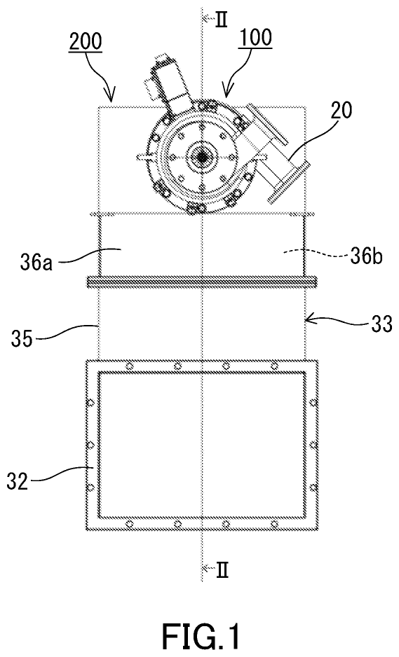

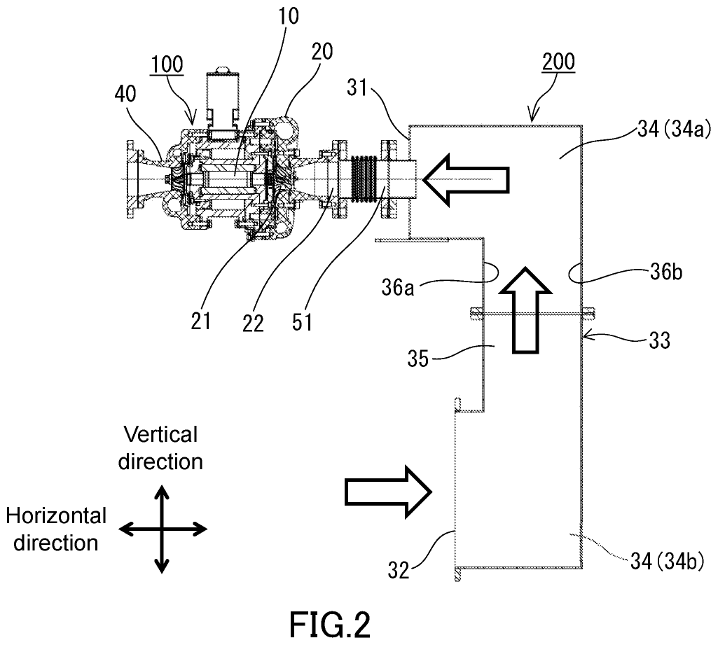

Embodiment 1 will be described below with reference to FIG. 1 and FIG. 2.

[1-1. Configuration]

FIG. 1 is a front view showing a suction pipe of a centrifugal compressor of Embodiment 1 together with the centrifugal compressor. FIG. 2 is a longitudinal sectional view of the suction pipe and the centrifugal compressor taken along line II-II.

In the present embodiment, a centrifugal compressor 20 includes a rotary shaft 10, an impeller 21 attached to the rotary shaft 10, and a suction port 22 that is open to direct the working fluid to the impeller 21. The suction port 22 is open toward the impeller 21. The rotary shaft 10 extends in the horizontal direction.

A suction pipe 200 is the suction pipe of the centrifugal compressor 20. The suction pipe 200 includes a first opening portion 31 to be directly or indirectly connected to the suction port 22 and a second opening portion 32 positioned upstream from the first opening portion 31 in the flow direction of the working fluid. The second opening portion 32 is positioned below the first opening portion 31 in the vertical direction. The first opening portion 31 and the second opening portion 32 are open toward the same direction. In the present embodiment, the first opening portion 31 and the second opening portion 32 are open toward the horizontal direction. According to such a structure, when the working fluid is introduced into the suction pipe 200 through the second opening portion 32, the flow direction of the working fluid is changed inside the suction pipe 200. When the flow direction of the working fluid is changed, ice flakes and water droplets contained in the working fluid deviate from the flow of the working fluid by the difference in inertial force due to the mass thus to collide with the wall surface of the suction pipe 200, and fall down along the wall surface by their own weights. Ice flakes and water droplets thus leave the working fluid, thereby suppressing the entry of ice flakes and water droplets into the centrifugal compressor 20 through the suction port 22. Consequently, it is possible to avoid damage to the impeller 21. In FIG. 2, the open arrows indicate the flow direction of the working fluid.

In the present embodiment, a heater or the like is not provided in the suction pipe 200. According to the present embodiment, it is possible to suppress the entry of ice flakes and water droplets into the centrifugal compressor 20, without using an external input such as electric power or heat. However, electric power, heat, or the like may be used in an auxiliary manner. Even in this case, an effect of reducing consumption of electric power and heat is obtained.

The working fluid is a gas to be pressurized by the centrifugal compressor 20. The working fluid is typically air. The working fluid may be a refrigerant for refrigerators.

The suction pipe 200 further includes a body portion 33 extending from the second opening portion 32 to the first opening portion 31. The body portion 33 includes at least one flow change portion 34 that changes the flow direction of the working fluid by 90 degrees or more. According to such a structure, in the flow change portion 34, ice flakes and water droplets contained in the working fluid deviate from the flow of the working fluid by the difference in inertial force due to the mass thus to collide with the wall surface of the suction pipe 200, and fall down along the wall surface by their own weights. This further suppresses the entry of ice flakes and water droplets into the centrifugal compressor 20 through the suction port 22.

In the present embodiment, the at least one flow change portion 34 includes a first flow change portion 34a positioned on the downstream side in the flow direction of the working fluid and a second flow change portion 34b positioned on the upstream side in the flow direction of the working fluid. The first flow change portion 34a and the second flow change portion 34b each change the flow direction of the working fluid by 90 degrees or more. It is possible to cause ice flakes and water droplets to collide with the respective wall surfaces of the two flow change portions 34, thereby further suppressing the entry of ice flakes and water droplets into the centrifugal compressor 20 through the suction port 22.

The body portion 33 includes an intermediate narrow portion 35 having a flow path cross-sectional area smaller than the opening area of the second opening portion 32. Such a structure increases the flow velocity of the working fluid in the intermediate narrow portion 35. With the increase of the flow velocity of the working fluid, the inertial force acting on ice flakes and water droplets is also increased. Consequently, in the first flow change portion 34a positioned downstream from the intermediate narrow portion 35 in the flow direction of the working fluid, ice flakes and water droplets contained in the working fluid more easily collide with the wall surface. Thus, small-sized ice flakes and water droplets that have not left the working fluid on the wall surface of the second flow change portion 34b are helped to leave the working fluid in the first flow change portion 34a. This even further suppresses the entry of ice flakes and water droplets into the centrifugal compressor 20 through the suction port 22.

The flow path cross-sectional area of the intermediate narrow portion 35 refers to the area of a section of the intermediate narrow portion 35 obtained by taking the intermediate narrow portion 35 along the horizontal plane. A cross section perpendicular to the flow direction of the working fluid is the flow path cross-sectional area. The opening area of the first opening portion 31 refers to the area of the first opening portion 31 as viewed in the outflow direction of the working fluid. The opening area of the second opening portion 32 refers to the area of the second opening portion 32 as viewed in the inflow direction of the working fluid.

The intermediate narrow portion 35 has a first wall surface 36a and a second wall surface 36b facing each other. In the present embodiment, the horizontal direction is a direction parallel to the direction from the first wall surface 36a toward the second wall surface 36b. In the horizontal direction, the distance from the first opening portion 31 to the first wall surface 36a is shorter than the distance from the first opening portion 31 to the second wall surface 36b. A quadrilateral having the smallest area to surround the flow path cross section of the intermediate narrow portion 35 is a rectangle. The first wall surface 36a and the second wall surface 36b are surfaces corresponding to a pair of long sides of the above rectangle. Such a structure further increases the flow velocity of the working fluid in the intermediate narrow portion 35. This further helps ice flakes and water droplets to leave the working fluid in the first flow change portion 34a.

In the present embodiment, the flow path cross section of the suction pipe 200 has a rectangular shape. Such a structure easily helps ice flakes and water droplets to collide with the wall surface in the flow change portion 34.

In the present embodiment, a portion from the second opening portion 32 to the second flow change portion 34b extends in a direction parallel to the axial direction of the rotary shaft 10 (horizontal direction). A portion from the second flow change portion 34b to the first flow change portion 34a extends in a direction orthogonal to the axial direction of the rotary shaft 10 (vertical direction). A portion from the first flow change portion 34a to the first opening portion 31 extends in the direction parallel to the axial direction of the rotary shaft 10. The first wall surface 36a is positioned closer to the first opening portion 31 than the second wall surface 36b is as viewed in the axial direction of the rotary shaft 10.

The opening area of the first opening portion 31 can be appropriately set according to the shape of the suction port 22 to be connected. The opening area of the first opening portion 31 may be larger than the opening area of the suction port 22. The larger the opening area of the first opening portion 31 relative to the opening area of the suction port 22 is, the lower the suction loss is suppressed. Consequently, the efficiency of the centrifugal compressor 20 is enhanced.

The opening area of the second opening portion 32 can be appropriately set according to the shape of the discharge port of the element to be connected to the second opening portion 32, for example, the heat exchanger.

In the suction pipe 200, the flow path length from the first opening portion 31 to the second opening portion 32 can be appropriately set according to, for example, the layout of the element to be connected to the second opening portion 32, for example, the heat exchanger and the centrifugal compressor 20. The flow path length from the first opening portion 31 to the second opening portion 32 should desirably be as short as possible. The shorter the flow path length from the first opening portion 31 to the second opening portion 32 is, the lower the suction loss is suppressed. Consequently, the efficiency of the centrifugal compressor 20 is enhanced. The “flow path length from the first opening portion 31 to the second opening portion 32” as used herein refers to the length of the flow path through which the working fluid flows from the inflow through the second opening portion 32 to the outflow through the first opening portion 31.

The material of the suction pipe 200 is not particularly limited. The suction pipe 200 may be formed of a metal material, such as stainless steel or steel.

Between the suction port 22 of the centrifugal compressor 20 and the first opening portion 31 of the suction pipe 200, a different element for connecting these elements may be provided. The different element may be, for example, a connecting member. In the present embodiment, the suction port 22 and the first opening portion 31 are indirectly connected to each other with a connecting member 51. The suction pipe 200 may be directly connected to the suction port 22.

In the present embodiment, the centrifugal compressor 20 is an expander-compressor unit 100. The expander-compressor unit 100 includes an expander 40 in addition to the centrifugal compressor 20. The centrifugal compressor 20 compresses the working fluid. The expander 40 is connected to the centrifugal compressor 20 via the rotary shaft 10 to expand the working fluid.

[1-2. Operation]

Next, an example of the operation of the centrifugal compressor 20 and the suction pipe 200 will be described.

Along with the rotation of the impeller 21, negative pressure is generated in the suction port 22 of the centrifugal compressor 20. The negative pressure causes the working fluid to be sucked into the centrifugal compressor 20 through the suction pipe 200. At this time, the working fluid has a flow velocity determined according to the negative pressure generated in the centrifugal compressor 20 and the flow path cross-sectional area of the suction pipe 200, thereby lowering the static pressure of the working fluid. In the case of the working fluid being air, at the static pressure of the working fluid equal to or lower than the saturated vapor pressure determined according to the temperature of the working fluid, water vapor contained in air condenses and appears in air as water droplets. Accordingly, in the case where air before being sucked into the centrifugal compressor 20 has a sufficiently low temperature, the air contains water droplets of condensed water and ice flakes resulting from freezing the water droplets.

When the working fluid is introduced into the suction pipe 200 through the second opening portion 32, the flow direction of the working fluid is changed inside the suction pipe 200. When the flow direction of the working fluid is changed, ice flakes and water droplets contained in the working fluid deviate from the flow of the working fluid by the difference in inertial force due to the mass thus to collide with the wall surface of the suction pipe 200, and fall down along the wall surface by their own weights.

The flow direction of the working fluid is changed in the flow change portion 34 by 90 degrees or more.

In the present embodiment, the flow direction of the working fluid is firstly changed in the second flow change portion 34b by 90 degrees. The flow direction is then changed in the first flow change portion 34a by 90 degrees.

[1-3. Effects etc.]

As described above, in the present embodiment, the second opening portion 32 is positioned below the first opening portion 31 in the vertical direction. The first opening portion 31 and the second opening portion 32 are open toward the same direction. According to such a structure, when the working fluid is introduced into the suction pipe 200 through the second opening portion 32, the flow direction of the working fluid is changed inside the suction pipe 200. Ice flakes and water droplets contained in the working fluid deviate from the flow of the working fluid by the difference in inertial force due to the mass thus to collide with the wall surface of the suction pipe 200, and fall down along the wall surface by their own weights. Ice flakes and water droplets thus leave the working fluid, thereby suppressing the entry of ice flakes and water droplets into the centrifugal compressor 20 through the suction port 22.

Furthermore, in the present embodiment, the suction pipe 200 further includes the body portion 33 extending from the second opening portion 32 to the first opening portion 31. The body portion 33 includes the at least one flow change portion 34 that changes the flow direction of the working fluid by 90 degrees or more. According to such a structure, in the flow change portion 34, ice flakes and water droplets contained in the working fluid deviate from the flow of the working fluid by the difference in inertial force due to the mass thus to collide with the wall surface of the suction pipe 200, and fall down along the wall surface by their own weights.

Furthermore, in the present embodiment, the body portion 33 includes the intermediate narrow portion 35 having a flow path cross-sectional area smaller than the opening area of the second opening portion 32. Such a structure increases the flow velocity of the working fluid in the intermediate narrow portion 35. Consequently, in the first flow change portion 34a positioned downstream from the intermediate narrow portion 35 in the flow direction of the working fluid, ice flakes and water droplets contained in the working fluid more easily collide with the wall surface.

Furthermore, in the present embodiment, the intermediate narrow portion 35 has the first wall surface 36a and the second wall surface 36b facing each other. In the direction parallel to the direction from the first wall surface 36a toward the second wall surface 36b, the distance from the first opening portion 31 to the first wall surface 36a is shorter than the distance from the first opening portion 31 to the second wall surface 36b. Such a structure further increases the flow velocity of the working fluid in the intermediate narrow portion 35. This further helps ice flakes and water droplets to leave the working fluid in the first flow change portion 34a.

Some other embodiments will be described below. The elements common to Embodiment 1 and the other embodiments are denoted by the same reference numerals, and the descriptions thereof may be omitted. The descriptions on the embodiments can be applied to each other unless they are technically contradictory. The embodiments may be combined with each other unless they are technically contradictory.

### EMBODIMENT 2

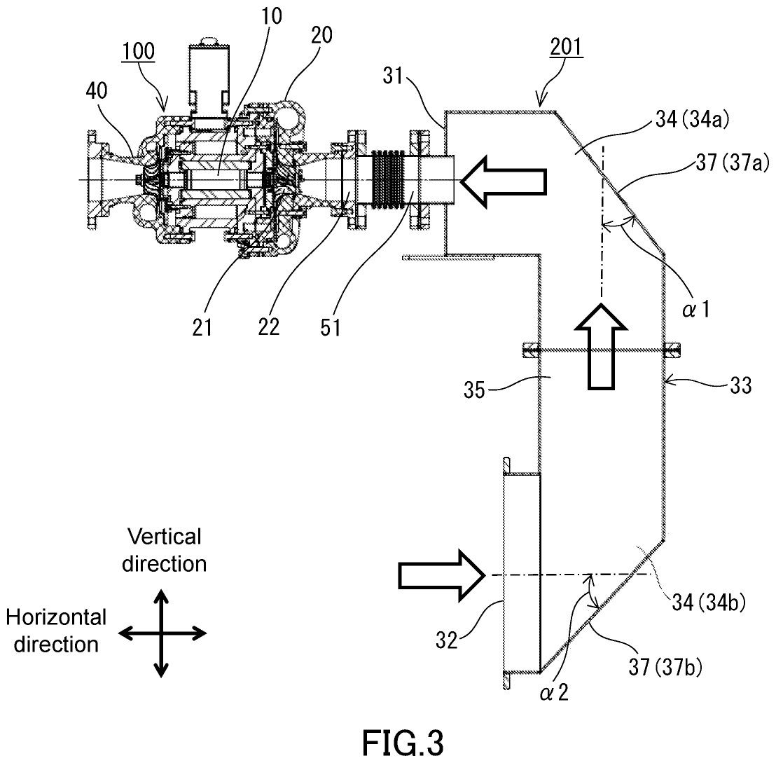

Embodiment 2 will be described below with reference to FIG. 3. FIG. 3 is a longitudinal sectional view showing a suction pipe of a centrifugal compressor of Embodiment 2 together with the centrifugal compressor. The front view of the suction pipe and the centrifugal compressor of Embodiment 2 is the same as the front view of the suction pipe and the centrifugal compressor of Embodiment 1 shown in FIG. 1, and accordingly the accompaniment thereof is omitted. In a suction pipe 201 of the present embodiment, the flow change portion 34 has a first collision surface 37. The suction pipe 201 has the same structure as the suction pipe 200 of Embodiment 1 except that the flow change portion 34 of the suction pipe 201 further has the first collision surface 37.

[2-1. Configuration]

The first collision surface 37 is a surface that is inclined at an angle of more than 0 degrees and less than 90 degrees relative to the direction in which the working fluid enters the flow change portion 34. Such a structure greatly changes the flow direction of the working fluid in the flow change portion 34, thereby helping small-sized ice flakes and water droplets to leave the working fluid. Furthermore, ice flakes and water droplets that have collided with the first collision surface 37 easily slide down along the first collision surface 37, which is inclined. Consequently, a larger amount of ice flakes and water droplets can be collected. The “direction in which the working fluid enters the flow change portion 34” can be the direction parallel to the axial direction of the rotary shaft (horizontal direction) or the direction orthogonal to the axial direction of the rotary shaft 10 (vertical direction).

In the present embodiment, the at least one flow change portion 34 includes the first flow change portion 34a positioned on the downstream side in the flow direction of the working fluid and the second flow change portion 34b positioned on the upstream side in the flow direction of the working fluid, as in the suction pipe 200 of Embodiment 1. The first flow change portion 34a and the second flow change portion 34b each have the first collision surface 37 (a first collision surface 37a and a first collision surface 37b). It is possible to cause ice flakes and water droplets to collide with the respective first collision surfaces 37 of the two flow change portions 34, thereby further suppressing the entry of ice flakes and water droplets into the centrifugal compressor 20 through the suction port 22.

In the present embodiment, the first collision surface 37b of the second flow change portion 34b is inclined at an angle α2 of more than 0 degrees and less than 90 degrees relative to the horizontal direction that is the direction in which the working fluid enters the second flow change portion 34b. The first collision surface 37a of the first flow change portion 34a is inclined at an angle α1 of more than 0 degrees and less than 90 degrees relative to the vertical direction that is the direction in which the working fluid enters the first flow change portion 34a. The angle α1 and the angle α2 may be equal to each other, or may be different from each other. The angle α1 and the angle α2 each may be more than 30 degrees and less than 60 degrees. In the example shown in FIG. 3, the angle α1 and the angle α2 are each 45 degrees.

In the present embodiment, the intermediate narrow portion 35 is positioned between the first flow change portion 34a and the second flow change portion 34b. According to such a structure, after passing through the second flow change portion 34b, the working fluid is accelerated in the intermediate narrow portion 35 and flows into the first flow change portion 34a. This further helps ice flakes and water droplets to leave the working fluid.

[2-2. Operation]

When the working fluid is introduced into the suction pipe 201 through the second opening portion 32, the flow direction of the working fluid is greatly changed in the flow change portion 34. Ice flakes and water droplets contained in the working fluid deviate from the flow of the working fluid by the difference in inertial force due to the mass thus to collide with the first collision surface 37, and fall down along the wall surface by their own weights.

The working fluid firstly collides with the first collision surface 37b in the second flow change portion 34b. The working fluid then collides with the first collision surface 37a in the first flow change portion 34a.

After passing through the second flow change portion 34b, the working fluid is accelerated in the intermediate narrow portion 35 and flows into the first flow change portion 34a.

[2-3. Effects Etc.]

As described above, in the present embodiment, the first collision surface 37 is a surface that is inclined at an angle of more than 0 degrees and less than 90 degrees relative to the direction in which the working fluid enters the flow change portion 34. Such a structure greatly changes the flow direction of the working fluid in the flow change portion 34, thereby helping small-sized ice flakes and water droplets to leave the working fluid. Furthermore, ice flakes and water droplets that have collided with the first collision surface 37 easily slide down along the first collision surface 37, which is inclined. Consequently, a larger amount of ice flakes and water droplets can be collected.

Furthermore, in the present embodiment, the at least one flow change portion 34 includes the first flow change portion 34a and the second flow change portion 34b, as in the suction pipe 200 of Embodiment 1. The first flow change portion 34a and the second flow change portion 34b each have the first collision surface 37. According to such a structure, it is possible to cause ice flakes and water droplets to collide with the respective first collision surfaces 37 of the two flow change portions 34.

Furthermore, in the present embodiment, the intermediate narrow portion 35 is positioned between the first flow change portion 34a and the second flow change portion 34b. According to such a structure, after passing through the second flow change portion 34b, the working fluid is accelerated in the intermediate narrow portion 35 and flows into the first flow change portion 34a. This further helps ice flakes and water droplets to leave the working fluid.

### EMBODIMENT 3

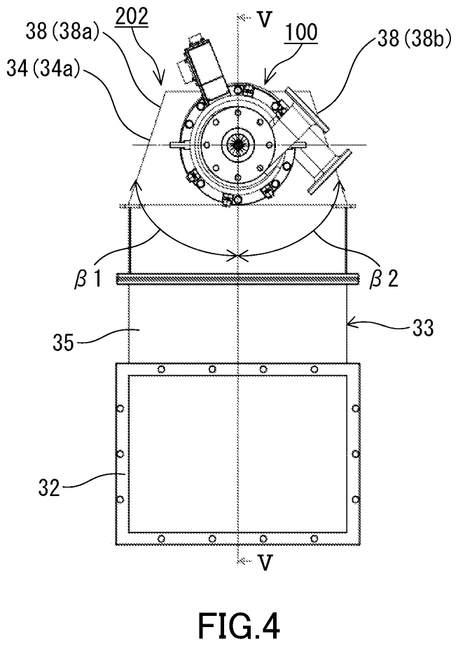

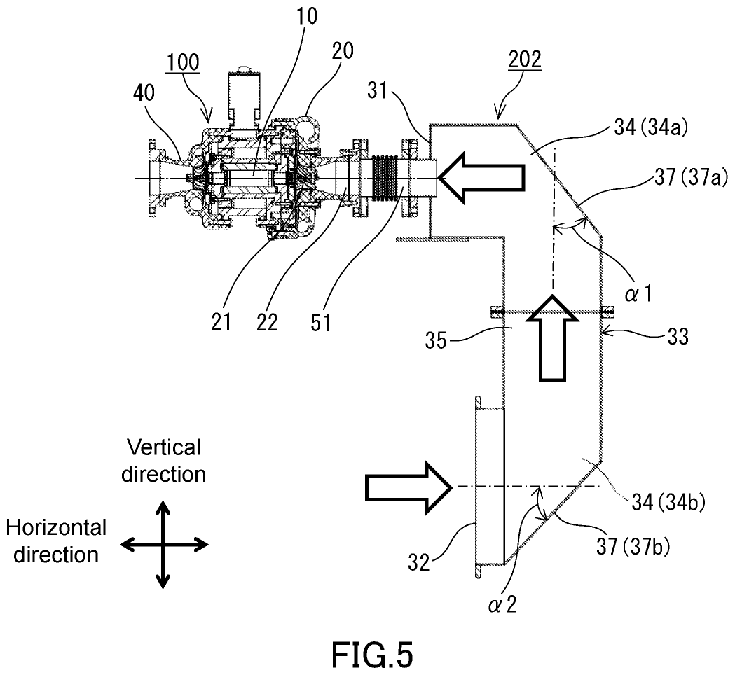

Embodiment 3 will be described below with reference to FIG. 4 and FIG. 5. FIG. 4 is a front view showing a suction pipe of a centrifugal compressor of Embodiment 3 together with the centrifugal compressor. FIG. 5 is a longitudinal sectional view of the suction pipe and the centrifugal compressor taken along line V-V. In a suction pipe 202 of the present embodiment, the flow change portion 34 has a second collision surface 38. The suction pipe 202 has the same structure as the suction pipe 201 of Embodiment 2 except that the flow change portion 34 of the suction pipe 202 further has the second collision surface 38.

[3-1. Configuration]

The second collision surface 38 is inclined relative to the first collision surface 37, and is inclined relative to the direction in which the working fluid enters the flow change portion 34. Such a structure increases the number of wall surfaces with which ice flakes and water droplets are to collide in the flow change portion 34, thereby further helping ice flakes and water droplets to leave the working fluid. The “direction in which the working fluid enters the flow change portion 34” can be the direction orthogonal to the axial direction of the rotary shaft 10 (vertical direction) or the direction parallel to the axial direction of the rotary shaft (horizontal direction).

In the present embodiment, the at least one flow change portion 34 includes the first flow change portion 34a positioned on the downstream side in the flow direction of the working fluid and the second flow change portion 34b positioned on the upstream side in the flow direction of the working fluid, as in the suction pipe 201 of Embodiment 2. The first flow change portion 34a and the second flow change portion 34b each may have the second collision surface 38. Either the first flow change portion 34a or the second flow change portion 34b may have the second collision surface 38. Only the first flow change portion 34a may have the second collision surface 38. Such a structure further helps ice flakes and water droplets to leave the working fluid immediately before the suction through the suction port 22.

The inclination direction of the second collision surface 38 is a direction in which the width of the first collision surface 37 is reduced along the flow direction of the working fluid. That is, the second collision surface 38 is inclined in a direction in which the flow path cross-sectional area of the flow change portion 34 is reduced as compared with the case where the second collision surface 38 is parallel to the vertical direction. Such a structure further increases the flow velocity of the working fluid in the flow change portion 34. This further helps ice flakes and water droplets to leave the working fluid in the flow change portion 34.

In the present embodiment, the second collision surface 38 is a surface adjacent to the first collision surface 37.

In the present embodiment, only the first flow change portion 34a has the second collision surface 38. The second collision surface 38 includes a second collision surface 38a and a second collision surface 38b facing each other. The second collision surface 38a is inclined at an angle β1 of more than 0 degrees and less than 90 degrees relative to the direction orthogonal to the axial direction of the rotary shaft 10 (vertical direction). The second collision surface 38b is inclined at an angle β2 of more than 0 degrees and less than 90 degrees relative to the direction orthogonal to the axial direction of the rotary shaft 10 (vertical direction). The second collision surface 38a and the second collision surface 38b are inclined in the inward direction of the suction pipe 202. The angle β1 and the angle β2 may be equal to each other, or may be different from each other. The angle β1 and the angle β2 each may be more than 15 degrees and less than 45 degrees. In the example shown in FIG. 4, the angle β1 and the angle β2 are each 30 degrees.

[3-2. Operation]

When the working fluid is introduced into the suction pipe 202 through the second opening portion 32, the flow direction of the working fluid is greatly changed in the flow change portion 34. Ice flakes and water droplets contained in the working fluid deviate from the flow of the working fluid by the difference in inertial force due to the mass thus to collide with not only the first collision surface 37 but also the second collision surface 38, and fall down along the wall surface by their own weights.

The working fluid firstly collides with the first collision surface 37b in the second flow change portion 34b. The working fluid then collides with the first collision surface 37a and the second collision surfaces 38a and 38b in the first flow change portion 34a.

[3-3. Effects Etc.]

As described above, in the present embodiment, the second collision surface 38 is inclined relative to the first collision surface 37, and is inclined relative to the direction in which the working fluid enters the flow change portion 34. Such a structure increases the number of wall surfaces with which ice flakes and water droplets are to collide in the flow change portion 34, thereby further helping ice flakes and water droplets to leave the working fluid.

Furthermore, in the present embodiment, the inclination direction of the second collision surface 38 is the direction in which the width of the first collision surface 37 is reduced along the flow direction of the working fluid. Such a structure reduces the flow path cross-sectional area of the flow change portion 34, thereby further increasing the flow velocity of the working fluid in the flow change portion 34. This further helps ice flakes and water droplets to leave the working fluid in the flow change portion 34.

### EMBODIMENT 4

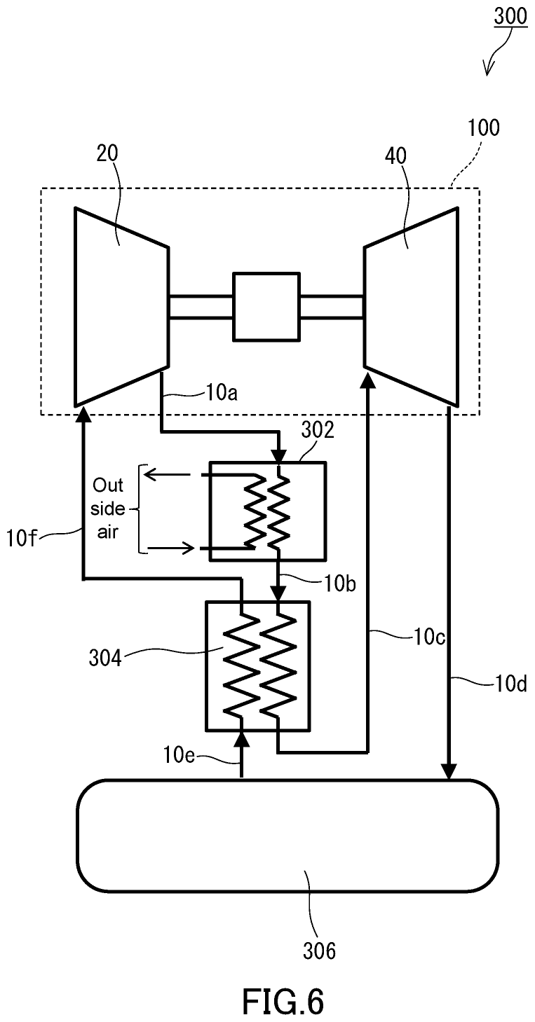

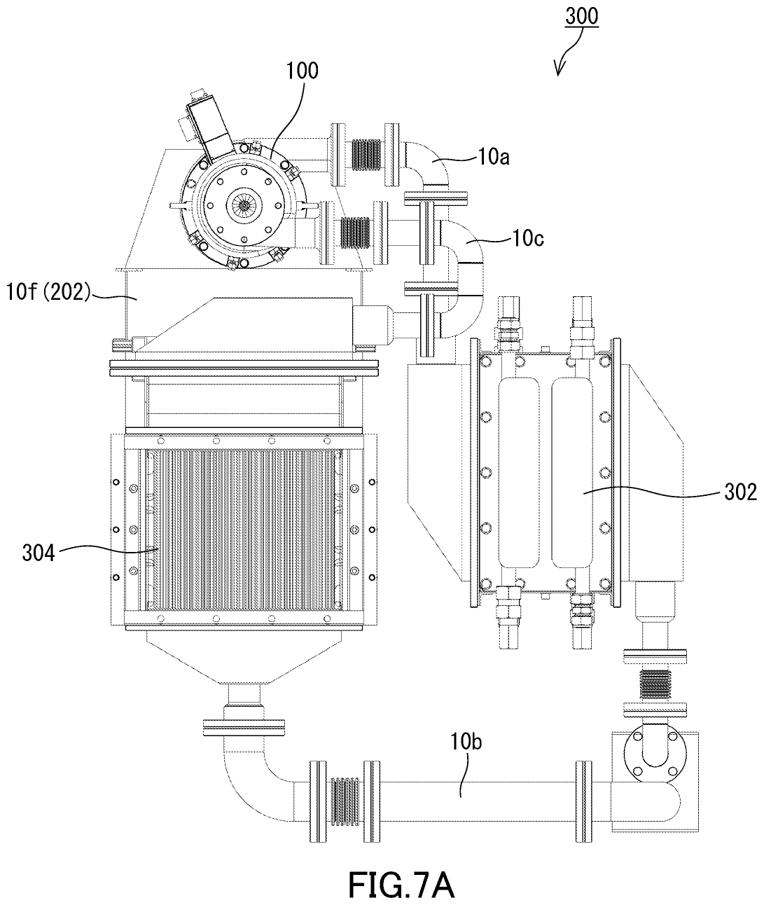

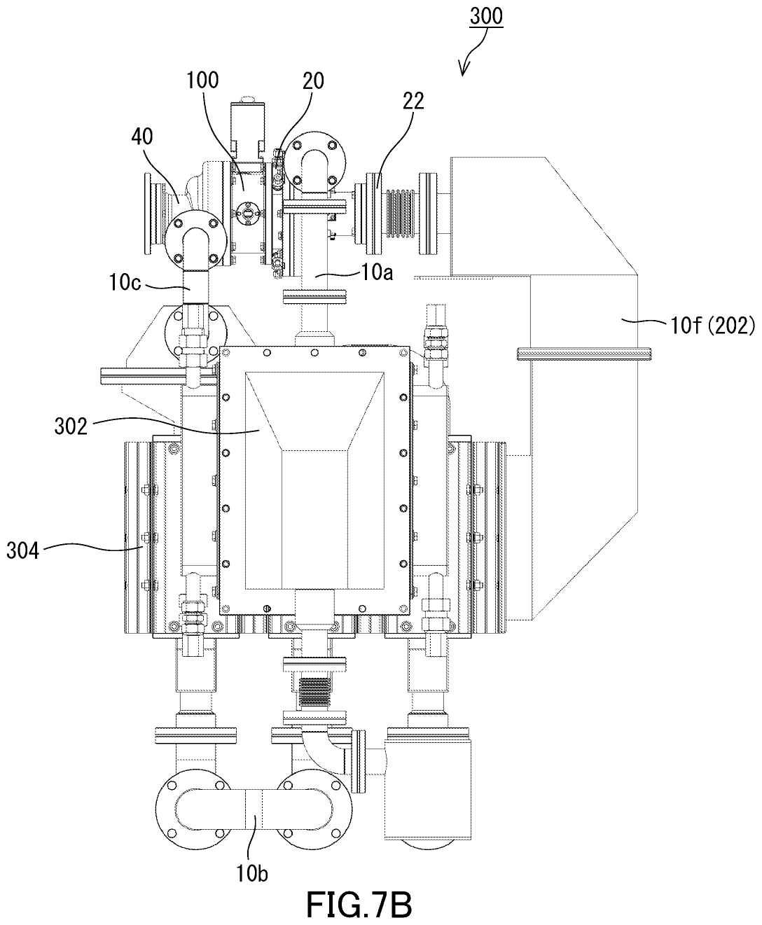

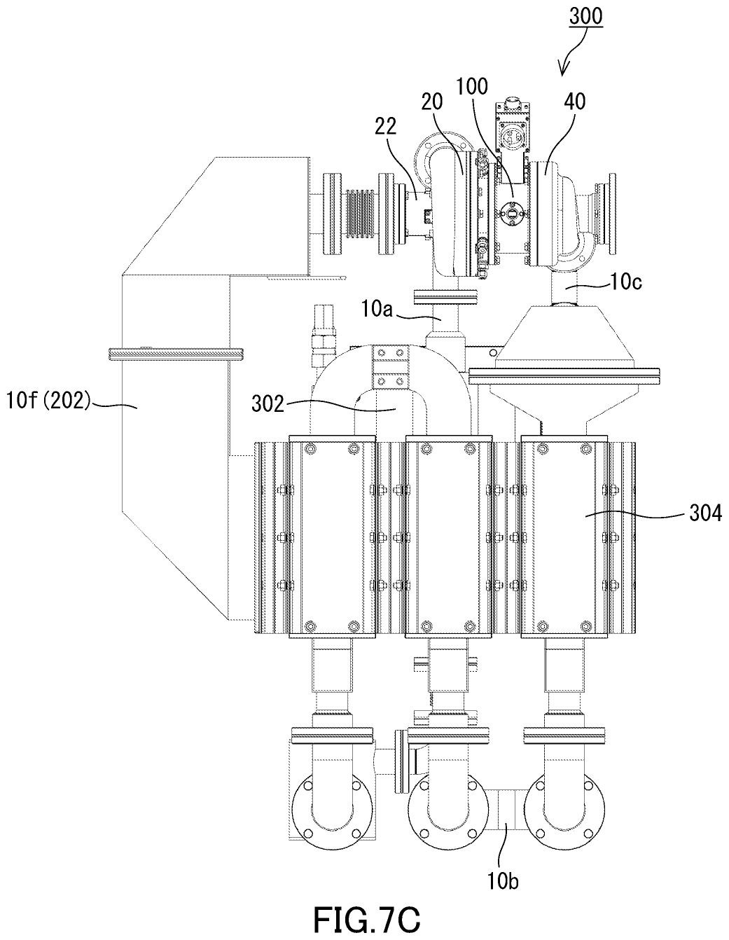

Embodiment 4 will be described below with reference to FIG. 6 and FIG. 7A to FIG. 7C. The same components as those of Embodiments 1 to 3 are denoted by the same reference numerals, and the detailed descriptions thereof will be omitted.

[4-1. Configuration]

FIG. 6 is a configuration diagram of a refrigerator of Embodiment 4. A refrigerator 300 includes the centrifugal compressor 20 of Embodiments 1 to 3. The centrifugal compressor 20 is the expander-compressor unit 100 of Embodiments 1 to 3. That is, the expander-compressor unit 100 includes the expander 40 in addition to the centrifugal compressor 20.

The refrigerator 300 further includes a first heat exchanger 302 and a second heat exchanger 304. A freezer 306 is connected to the refrigerator 300. The thermal cycle of the refrigerator 300 is an air refrigeration cycle in which air is used as the refrigerant that is the working fluid. A low-temperature air generated by the refrigerator 300 is directed to the freezer 306. The refrigerator 300 may be used for cabin air conditioning in aircraft. Since the global warming potential (GWP) of air is zero, it is desirable to use air as the refrigerant from the viewpoint of global environment protection. Furthermore, by using air as the refrigerant, the refrigerator 300 can be constituted as an open system.

The expander-compressor unit 100, the first heat exchanger 302, the second heat exchanger 304, and the freezer 306 are connected to each other by flow paths 10a to 10f. The flow path 10a connects the discharge port of the centrifugal compressor 20 and the inlet of the first heat exchanger 302. The flow path 10b connects the refrigerant outlet of the first heat exchanger 302 and the high-pressure side inlet of the second heat exchanger 304. The flow path 10c connects the high-pressure side outlet of the second heat exchanger 304 and the suction port of the expander 40. The flow path 10d connects the discharge port of the expander 40 and the inlet of the freezer 306. The flow path 10e connects the outlet of the freezer 306 and the low-pressure side inlet of the second heat exchanger 304. The flow path 10f connects the low-pressure side outlet of the second heat exchanger 304 and the suction port of the centrifugal compressor 20. In the flow paths 10a to 10f, other equipment may be disposed such as another heat exchanger and a defroster.

The first heat exchanger 302 performs heat exchange between the outside air and high-temperature and high-pressure air discharged from the centrifugal compressor 20 to cool the air, and releases heat to the outside air. As the first heat exchanger 302, a known heat exchanger such as a fin tube heat exchanger can be used.

The second heat exchanger 304 performs heat exchange between cold air sucked from the freezer 306 and the air cooled by the first heat exchanger 302 and having a high pressure and a higher temperature than the outside air temperature. As the second heat exchanger 304, a plate heat exchanger can be used, for example.

FIG. 7A is a front view of the refrigerator 300. FIG. 7B is a right-side view of the refrigerator 300. FIG. 7C is a left-side view of the refrigerator 300. In FIG. 7A to FIG. 7C, the freezer 306, which is to be connected to the refrigerator 300, is omitted.

In the present embodiment, one selected from the suction pipes 200, 201, and 202 of Embodiments 1 to 3 is connected to the centrifugal compressor 20. The suction pipes 200, 201, and 202 of Embodiments 1 to 3 correspond to the flow path 10f in FIG. 6. That is, the suction pipes 200, 201, and 202 of Embodiments 1 to 3 connect the low-pressure side outlet of the second heat exchanger 304 and the suction port 22 of the centrifugal compressor 20. In FIG. 7A to FIG. 7C, the suction pipe 202 of Embodiment 3 is shown as an example of the flow path 10f in FIG. 6.

The expander-compressor unit 100 is positioned above the second heat exchanger 304 in the vertical direction. That is, the centrifugal compressor 20 is positioned above the second heat exchanger 304 in the vertical direction. The refrigerant passes through the second heat exchanger 304, moves in the vertical direction, and then flows into the centrifugal compressor 20. This positional relation is suitable for suppressing the occupied area of the refrigerator 300 and suppressing the entry of ice flakes and water droplets into the centrifugal compressor 20. Furthermore, the suction pipe 202 (200 or 201) is adopted as the movement path of the refrigerant in the vertical direction. This further enhances the effect of suppressing the entry of ice flakes and water droplets into the centrifugal compressor 20. Since the entire centrifugal compressor 20 is positioned above the second heat exchanger 304, the length of the suction pipe 202 in the vertical direction also can be sufficiently achieved.

[4-2. Operation]

The refrigerant compressed in the centrifugal compressor 20 is cooled in the first heat exchanger 302 and the second heat exchanger 304. The cooled refrigerant expands in the expander 40. This further lowers the temperature of the refrigerant. The low-temperature refrigerant is supplied to the freezer 306. The refrigerant discharged from the freezer 306 is heated in the second heat exchanger 304, and then is introduced into the centrifugal compressor 20. In an example, the temperature of the refrigerant at the inlet of the centrifugal compressor 20 is 20° C. The temperature of the refrigerant at the outlet of the centrifugal compressor 20 is 85° C. The temperature of the refrigerant at the refrigerant outlet of the first heat exchanger 302 is 40° C. The temperature of the refrigerant at the inlet of the expander 40 is −30° C. The temperature of the refrigerant at the outlet of the expander 40 is −70° C.

The power obtained by the air expansion in the expander 40 is regenerated as the power of the centrifugal compressor 20.

The refrigerator 300 of the present embodiment includes the centrifugal compressor 20. According to the present embodiment, it is possible to provide the refrigerator 300 in which the entry of ice flakes and water droplets into the centrifugal compressor 20 is suppressed.

### OTHER EMBODIMENTS

As described above, Embodiments 1 to 4 have been described as an illustration of the technique disclosed in the present application. However, the technique according to the present disclosure is not limited to these, and can be applied also to embodiments obtained by making modifications, replacements, additions, omissions, and the like. Furthermore, the components described in Embodiments 1 to 4 above can be combined to obtain a new embodiment as well.

The refrigerator 300 may include the freezer 306 in addition to the expander-compressor unit 100, the first heat exchanger 302, and the second heat exchanger 304. That is, the refrigerator 300 may include the freezer 306 as its component.

In the refrigerator 300, the heat release destination of the first heat exchanger 302 is not limited to the outside air, and may be other medium such as water.

### INDUSTRIAL APPLICABILITY

The technique of the present disclosure is applicable to rotary machines such as compressors and prime movers for electric generation.

1. A suction pipe of a centrifugal compressor, the centrifugal compressor having a suction port that is open to direct a working fluid to an impeller,
the suction pipe comprising:
a first opening portion to be directly or indirectly connected to the suction port; and
a second opening portion positioned upstream from the first opening portion in a flow direction of the working fluid, wherein
the second opening portion is positioned below the first opening portion in a vertical direction, and
the first opening portion and the second opening portion are open toward the same direction.

2. The suction pipe according to claim 1 further comprising a body portion extending from the second opening portion to the first opening portion, wherein
the body portion comprises at least one flow change portion configured to change the flow direction of the working fluid by 90 degrees or more.

3. The suction pipe according to claim 2, wherein
the at least one flow change portion has a first collision surface, and
the first collision surface is a surface that is inclined at an angle of more than 0 degrees and less than 90 degrees relative to a direction in which the working fluid enters the at least one flow change portion.

4. The suction pipe according to claim 2 or 3, wherein
the body portion comprises an intermediate narrow portion having a flow path cross-sectional area smaller than an opening area of the second opening portion.

5. The suction pipe according to claim 3, wherein
the at least one flow change portion comprises a first flow change portion positioned on a downstream side in the flow direction of the working fluid and a second flow change portion positioned on an upstream side in the flow direction of the working fluid, and
the first flow change portion and the second flow change portion each have the first collision surface.

6. The suction pipe according to claim 5, wherein
the body portion further comprises an intermediate narrow portion positioned between the first flow change portion and the second flow change portion, and
the intermediate narrow portion has a flow path cross-sectional area smaller than an opening area of the second opening portion.

7. The suction pipe according to claim 4, wherein
the intermediate narrow portion has a first wall surface and a second wall surface facing each other,
in a direction parallel to a direction from the first wall surface toward the second wall surface, a distance from the first opening portion to the first wall surface is shorter than a distance from the first opening portion to the second wall surface,
a quadrilateral having a smallest area to surround a flow path cross section of the intermediate narrow portion is a rectangle, and
the first wall surface and the second wall surface are surfaces corresponding to a pair of long sides of the rectangle.

8. The suction pipe according to claim 3, wherein
the at least one flow change portion further has a second collision surface, and
the second collision surface is inclined relative to the first collision surface, and is inclined relative to the direction in which the working fluid enters the at least one flow change portion.

9. The suction pipe according to claim 8, wherein
an inclination direction of the second collision surface is a direction in which a width of the first collision surface is reduced along the flow direction of the working fluid.

10. A centrifugal compressor with a suction pipe comprising:
a centrifugal compressor; and
the suction pipe according to claim 1, the suction pipe being connected to the centrifugal compressor.

11. A refrigerator comprising the centrifugal compressor with a suction pipe according to claim 10.
